(19) United States
(12) Patent Application Publication
(10) Pub. No.: US 2003/0179322 A1
(43) Pub. Date: Sep. 25, 2003

(54) Liquid crystal colour display device

(76) Inventor: Jean Jacque Sacre, Chateuagiron (FR)

Correspondence Address: Joseph S Tripoli, Patents Operations, Thomson Multimedia Licensing Inc, CN 5312, Princeton, NJ, 08543-0028, US

(21) Appl. No.: 10/362,619

(22) PCT Filed: Aug. 10, 2001
(86) PCT No.: PCT/FR01/02596

(51) Int. Cl. G02F 1/1335

(52) U.S. Cl. 349/5

(57) ABSTRACT

The invention relates to a liquid-crystal colour display device comprising a white light source (1); means for forming complementary light beams B, G and R; at least one liquid-crystal matrix equipped with optical means for focusing, onto liquid crystals assigned to each of the primary colours, the beams B,G,R, modifying the light emitted by the liquid crystals; and an optical system (15) for projecting the liquid-crystal images onto a screen, merging them by elementary spots. The device comprises optical splitting means (S) forming two elementary sources (1a, 1b) containing a mixture of the colours B, G and R, these sources (1a, 1b) being separate, and at least two optical channels (Cg,Crb) comprising an LCD matrix (Mg, Mrb), one of the channels (Cg) being assigned to the single colour G, the other channel or channels being assigned to the two other colours B and R.

The invention relates to a liquid-crystal colour display device of the kind of those comprising:

a polychromatic, especially white, light source;

means for forming, from this light source, complementary light beams, the wavelength ranges of which are different and correspond to the three primary colours blue B, green G and red R, respectively;

at least one liquid-crystal matrix equipped with optical means for focusing, onto liquid crystals assigned to each of the primary colours respectively, the corresponding complementary light beams, electronic means being provided to act on the liquid crystals and modify the light emitted by them, according to the desired intensities; and

an optical system for projecting the liquid-crystal images onto a screen, merging them by elementary spots.

Colour display devices of this type are known, these commonly being referred to as “spatiochromatic projectors”, in which the white light emitted by the source is formed as a parallel beam directed onto three dichroic mirrors inclined at different angles with respect to the mean direction of the beam of white light. The three dichroic mirrors are used to produce three complementary light beams corresponding to the primary colours B, G and R. These three beams have slightly different angles of incidence on the liquid-crystal matrix so that each elementary beam is focused at different points where liquid crystals assigned to the primary colours are located. It will be recalled that liquid crystals are not self-illuminating and that they must be illuminated in order to constitute spots of light.

In such a device, each horizontal line of the liquid-crystal matrix therefore comprises a succession of liquid crystals, also referred to as pixels, assigned to B, G, R; B, G, R; etc. On the screen where the projection takes place, a single elementary spot corresponds to three elementary pixels B, G, R, the colour of the spot depending on the intensity of each corresponding elementary pixel B, G, R.

It is therefore immediately apparent that the definition in the horizontal direction of the image projected onto the screen is reduced. For example, if the liquid-crystal matrix comprises 999 pixels along a horizontal line, there will only be 999/3=333 coloured spots on a horizontal line projected onto the screen.

It would be conceivable to improve the horizontal definition by increasing the number of pixels per horizontal line of the liquid-crystal matrix. However, this may result in a vertical/horizontal imbalance and problems of the optical aperture relating to the means provided with the liquid-crystal matrix for forming the image of the beams on the pixels.

Furthermore, it is known that the sensitivity of the human eye is not uniform over all the frequencies and it is a maximum for green light.

It would therefore be desirable to take into account this fact in order to improve the colour rendition.

Thus, it is an object of the invention, above all, to provide a liquid-crystal colour display device which makes it possible to improve the resolution of the image projected onto the screen and the colour rendition, without correspondingly complicating the manufacture of the liquid-crystal matrix.

According to the invention, a liquid-crystal colour display device, of the kind defined above, is characterized in that it comprises:

optical splitting means for forming, from the polychromatic light source, at least two elementary sources having different wavelength ranges that contain, however, a mixture of the primary colours B, V, R, these elementary sources being geometrically separate; and

at least two optical channels each comprising a liquid-crystal matrix, one of the channels being assigned to the single primary colour G, the other channel(s) being assigned to the other two primary colours B and R.

Preferably, only two optical channels are provided and the liquid-crystal matrices assigned to each channel are identical, with the same number of pixels, so that the resolution in the G (green) channel is twice the resolution for the two other primary colours B and R which share the pixels of the other matrix.

Advantageously, the optical splitting means for forming the two elementary sources comprise a means for deflecting the light according to the wavelength, in particular a grating, and preferably a corrective prism, placed at the exit of the white light source. Two light guides receive a portion of the beam, each guide giving, as output, an elementary source whose wavelength range differs from that of the other elementary source. A first elementary source may correspond to a smaller wavelength range, for example the lower portion of the visible spectrum from 420 nm to 550 nm, and the other elementary source corresponds to a larger wavelength range, for example the upper portion of the visible spectrum from 550 nm to 680 nm.

An optical divider is provided at the exit of the two light guides in order to produce two optical channels, one assigned to the single colour green G, the other to the colours blue B and red R. The divider may consist of a dichroic filter that reflects B and R and transmits G, or vice versa by a dichroic filter that transmits B and R and reflects G.

Preferably, the two optical channels are placed at 90° as are the two matrices assigned to each of these channels. The dichroic filter is inclined at 45° to the optical axis. The merging of the two channels is then achieved by means of a dichroic recombining mirror or a semi-transparent mirror inclined at 45°.

The outputs of the two light guides correspond to the two complementary sources and are spaced a few millimetres apart, these sources making it possible to illuminate the liquid-crystal matrices at two different angles so that the beams are focused onto two neighbouring pixels; in the case of the green channel, two neighbouring pixels are illuminated by two beams of green light, whereas in the case of the red-blue channel, two neighbouring pixels are assigned to the red and to the blue, respectively.

Preferably, a Fresnel lens is placed between the optical divider and the liquid-crystal matrices. Also preferably, a simple mirror is placed between the Fresnel lens and the liquid-crystal matrices in order to fold the beam preferably at 90°.

The invention consists, apart from the abovementioned arrangements, of a certain number of other arrangements, which will be n explained in greater detail below with regard to an example which is described with reference to the drawings appended hereto but which is in no way limiting.

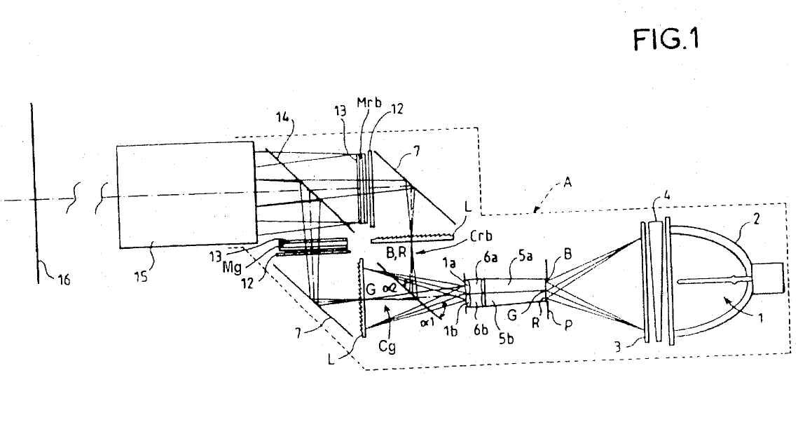

FIG. 1 of these drawings is a diagram of an overall liquid-crystal colour display device according to the invention.

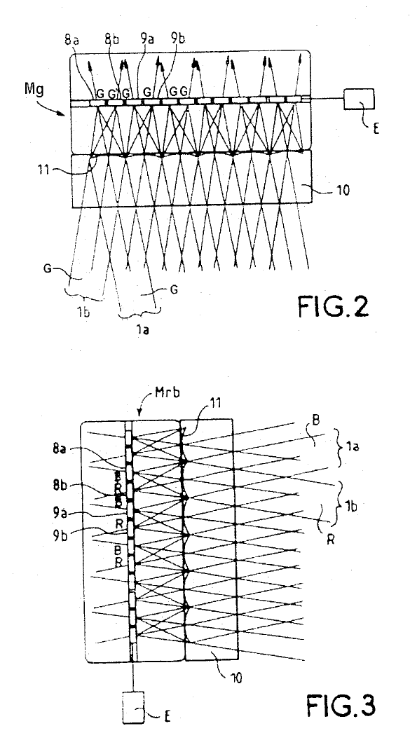

FIG. 2 is a diagram on a larger scale of part of the liquid-crystal matrix with microlenses for the green.

Finally, FIG. 3 shows, in a manner similar to FIG. 2, the liquid-crystal matrix with microlenses for the blue and the red.

FIG. 1 shows a liquid-crystal colour display device A. This device comprises a white light source 1, formed for example by an electric arc, equipped with an ellipsoidal reflector 2. The light from the source 1 is a mixture of the three primary colours, namely blue B, green G and red R.

Optical splitting means S are provided for forming, from the white light source 1, two elementary sources 1a, 1b having different wavelength ranges. The two elementary sources 1a, 1b are geometrically separated.

The optical splitting means S comprise a grating 3, for example having 220 l/mm (lines per millimetre), which deflects the light differently according to the wavelength. In a plane P at some distance from the grating, the light is spread over a direction orthogonal to the direction of propagation. Schematically, and in order to simplify matters, three regions B, G and R have been shown. In reality, the separation of the wavelengths is not abrupt but progressive, in particular in the case of a continuous spectrum.

To prevent aberrations (chromatic coma) generated by the grating 3, it is advantageous to provide a prism 4, placed between the grating 3 and the source 1, which provides a good correction and keeps the optical axis on the axis of the lamp 1.

Two juxtaposed light guides 5a, 5b are placed on either side of the optical axis of the lamp 1, with one face on this axis. Each guide 5a, 5b may be formed by a truncated pyramid made of glass or transparent plastic, with parallel bases perpendicular to the direction of the optical axis; the small base is turned towards the grating 3. The entrance faces of the guides 5a, 5b lie in the plane P. The guide 5a, located on top in the representation shown in FIG. 1, receives essentially the wavelengths going from green to blue, for example from 550 nm to 420 nm, whereas the guide 5b receives essentially the wavelengths going from green to red, for example from 550 nm to 680 nm.

Each guide 5a, 5b is equipped at the exit with a condenser 6a, 6b forming the elementary source 1a, 1b. The centres of the two sources 1a, 1b are spaced apart perpendicular to the optical axis of the lamp 1. The light emitted by each elementary source 1a, 1b contains a mixture of the primary colours.

A gradient dichroic filter F1 is placed after the guides 5a, 5b, the filter being inclined at an angle of 45° to the optical axis.

The mean direction of the light rays emanating from the sources 1a, 1b in the vicinity of one end of the filter F1 takes an angle α1 with this filter, whereas on the other end the angle of the mean direction of the rays with the filter F1 is α2. The filter F1 is designed so that the cut-off frequency, within the wavelengths, is the same or approximately the same for both angles α1 and α2.

The gradient dichroic filter F1 is designed, for example, to transmit the green G, and reflect the blue B and the red R. The diagram in FIG. 1 corresponds to such a dichroic filter F1.

As a variant, the gradient dichroic filter could be designed to reflect G and transmit B and R.

The filter F1 gives rise to two optical channels Cg and Crb, each comprising a liquid-crystal matrix Mg, Mrb. The channel Cg, with its matrix Mg, is assigned to the single primary colour G, whereas the other channel Crb with its matrix Mrb is assigned to the other two primary colours R and B.

The channel Cg includes, after the filter F1, a Fresnel lens L, for example made of plastic, perpendicular to the optical axis of the source 1 and giving a parallel light beam.

Placed after the Fresnell lens L is a simple mirror 7, inclined at 45° to the optical axis, in order to deflect the beam by 90°.

The liquid-crystal matrix Mg is placed after the mirror 7 at right angles to the lens L.

As may be seen in FIG. 2, the matrix Mg comprises transmissive liquid crystals or elementary pixels 8a, 8b, 9a, 9b placed in a plane perpendicular to the mean direction of the light. Lines of parallel pixels, similar to those shown in FIG. 2, follow one after another in a direction perpendicular to the plane of FIG. 2. The pixels are associated in pairs 8a, 8b, etc., each pixel of a pair corresponding to one of the elementary sources 1a, 1b. An image of the source 1a, 1b is formed on the corresponding pixels 8a, 9a; 8b, 9b, etc.

For this purpose, the liquid-crystal matrix (LCD matrix) is equipped with a transparent plate 10, made of plastic or glass, on one face of which plate microlenses 11 are formed, these microlenses consisting of convex cylindrical surfaces which generatrices perpendicular to the plane of FIG. 2. Any one microlens 11 receives, at two different angles, two parallel beams emanating from the sources 1a, 1b. The difference in the angles of incidence provides the geometrical separation of the sources 1a, 1b. Each beam of a different angle of inclination will be focused onto a respective pixel.

In the case of the matrix Mg, two pixels of a pair 8a, 8b will be illuminated with green G (with, however, slight differences in the mean wavelengths), this being indicated in FIG. 2 by the letter G assigned to each dixel.

The matrix Mrb is preferably identical to the matrix Mg, with the same number of pixels. The parallel beam of blue light B emanates from 1a and its angle of inclination is different from that of the beam of red light R emanating from 1b. The blue light beam B is focused, for example, onto the pixels 8a, 9a, etc. that have been assigned the letter B, whereas the beam of red light R is focused onto the pixels 8b, 9b, etc. that have been assigned to the letter R. The number of spots B and spots R will be half as numerous as the number of spots G.

Electronic means E are provided for driving each elementary pixel 8a, 8b, 9a, 9b, etc. according to the desired light intensity for this pixel in response to the illumination provided by the microlenses 10.

In summary, the two complementary sources 1a, 1b spaced a few millimetres apart, formed by the outputs of the light guides 5a, 5b, are used to illuminate the liquid crystals at two different angles so that the energy emanating from a source 1a is focused onto a pixel 8a and the energy emanating from the other source 1b is focused onto the neighbouring pixel 8b, this scheme being repeated every two pixels along the same line.

Placed just in front of the liquid-crystal matrix Mg or Mrb is a polarizer filter 12 for reducing the parasite light. An analyser filter 13 is placed at the exit of the liquid-crystal matrix.

The second channel Crb is deflected through a right angle by the filter F1 relative to the optical axis of the source 1. This channel Crb also includes a Fresnel lens L followed by a simple mirror 7 inclined at 45° in order to send the light along an axis parallel to that of the source 1 onto the matrix Mrb placed at right angles to the matrix Mg.

The two beams emitted by the liquid-crystals of the matrices Mg and Mrb are merged by a semi-transparent mirror 14 inclined at 45° to the bisector of the planes of the two matrices Mg and Mrb. The mirror 14 may be aligned with the filter F1. The mirror 14 may also advantageously be a recombining dichroic mirror.

Provided after the mirror 14 is a wide-angle objective 15 (for example with an F/D ratio of about 1.6) which projects the elementary spots of the image, that are obtained by merging the modulated pixels G, B and R, onto a screen 16. The screen 16 may be translucent, in order to observe the image on the opposite side from the objective 15.

The operation of the projector results from the above explanations.

A light beam essentially consisting of B and G propagates through the light guide 5a, whereas a beam essentially composed of G and R propagates through the light guide 5b. The two elementary sources 1a and 1b geometrically spaced apart emit light beams whose wavelength ranges differ.

The dichroic filter F1 lets through the component G of the beams emanating from the sources 1a and 1b. These beams are incident on the liquid-crystal matrix Mg at two slightly different angles. Each beam is focused onto an associated liquid crystal.

Each liquid crystal or pixel 8a, 8b, etc. of the matrix Mg, illuminated in this way, emits or transmits a green light whose intensity is modulated by the control signal delivered by the electronic means E relating to the pixel in question.

The component B of the beam emanating from the source 1a is 1 reflected by the dichroic filter F1. The same applies to the component R of the beam emanating from the source 1b. The two beams B and R are directed onto the liquid-crystal matrix Mrb at slightly different angles. The beam B will be focused, for example, onto the liquid crystals 8a, 9a, etc. of the matrix Mrb, whereas the beam R will be focused, for example, onto the liquid crystals 8b, 9b, etc. of the matrix Mrb. The elementary pixels B and R will have a light intensity that depends on the instructions delivered by the electronic beams E.

Next, the light spots formed by the pixels of the matrix Mg and by the pixels of the matrix Mrb are merged. The objective 15 projects the merged elementary spots onto the screen 16.

The whole system is designed so that each coloured spot of the image projected onto the screen 16 results from the merging of the two pixels G, for example 8a, 8b of the matrix Mg and of a pixel B and a pixel R, for example 8a and 8b respectively, of the matrix Mrb.

Preferably, the two matrices Mg and Mrb are identical and consist, for example, of XGA (1024×768) LCD matrices, that is to say 1024 pixels along the horizontal direction and 768 pixels along the vertical direction.

The system uses two guides 5a, 5b which accomplish the spectral splitting and the combining. The splitting is achieved by the physical limitation of the entrance of the two guides, such that one transmits the lower portion of the visible spectrum, from 550 nm to 420 nm, and the other the upper portion, from 680 nm to 550 nm. The guides 5a, 5b combine the spectra in question, the output of the guides accomplishing the angular splitting intended for the spatiochromatic effect.

Two objectives or condensers 6a, 6b are used at the exit of the guides in order to form the image of this output in the plane of the LCDs.

In a projector with two transmissive LCDs Mg and Mrb, one of which is intended for the green G and the other for the blue B and the red R the splitting is effected by a 45° mirror or filter F1 and the recombining likewise by a mirror 14, the two mirrors being in mutual alignment, and the LCDs being at 45° to these mirrors and at 90° to each other.

A projection objective 15 of sufficient aperture is provided in order to admit the extent of the beam generated by the illumination system.

The projection device according to the invention makes it possible to improve the overall resolution compared with a projector in which the three primary colours B, G and R are decomposed along a single line of pixels of a single matrix. Furthermore, the colour rendition is better since the green, to which the eye is most sensitive, benefits from a higher efficiency coefficient.

The aperture of the projection objective 15 is smaller; this objective is therefore less expensive and easier to produce.

The spectral splitting is improved and contamination of one channel by another in the case in which mirrors are used is avoided.

The losses, relative to a two-mirror spatiochromatic projector, are lower as the exit distance after the lens is shorter.

1. Liquid-crystal colour display device comprising:
a polychromatic, especially white, light source (1);
means for forming, from this light source, complementary light beams, the wavelength ranges of which are different and correspond to the three primary colours blue B, green G and red R, respectively;
at least one liquid-crystal matrix equipped with optical means for focusing, onto liquid crystals assigned to each of the primary colours respectively, the corresponding complementary light beams (B, G, R), electronic means (E) being provided to act on the liquid crystals and modify the light emitted by them, according to the desired intensities; and
an optical system (15) for projecting the liquid-crystal images onto a screen, merging them by elementary spots;
characterized in that it comprises:
optical splitting means (S) for forming, from the polychromatic light source, at least two elementary sources (1a, 1b) having different wavelength ranges that contain, however, a mixture of the primary colours B. G, R, these elementary sources (1a, 1b) being geometrically separate; and
at least two optical channels (Cg, Crb) each comprising a liquid-crystal matrix (Mg, Mrb), one of the channels (Cg) being assigned to the single primary colour G, the other channel(s) being assigned to the other two primary colours B and R.

2. Display device according to claim 1, characterized in that only two optical channels (Cg, Crb) are provided.

3. Display device according to claim 1, characterized in that the liquid-crystal matrices (Mg, Mrb) assigned to each channel are identical, with the same number of pixels, so that the resolution in the G (green) channel is twice the resolution for the two other primary colours B and R which share the pixels of the other matrix.

4. Display device according to one of the preceding claims, characterized in that the optical splitting means (S) comprise a means for deflecting the light according to the wavelength, in particular a grating (3).

5. Display device according to claim 4, characterized in that a corrective prism (4) is placed at the exit of the light source (1).

6. Display device according to claim 4 or 5, characterized in that two light guides (5a, 5b) receive a portion of the beam, each guide (5a, 5b) giving, as output, an elementary source (1a, 1b) whose wavelength range differs from that of the other elementary source.

7. Display device according to one of the preceding claims, characterized in that a first elementary source (1a) corresponds to a smaller wavelength range and the other elementary source (1b) corresponds to a larger wavelength range.

8. Display device according to claim 7, characterized in that the first elementary source (1a) corresponds to the lower portion of the visible spectrum, from 420 nm to 550 nm, and the other elementary source (1b) corresponds to the upper portion of the visible spectrum, from 550 nm to 680 nm.

9. Display device according to claim 6, characterized in that an optical divider (F1) is provided at the exit of the two light guides in order to produce two optical channels, one (Cg) assigned to the single colour green G, the other (Crb) to the colours blue B and red R.

10. Display device according to claim 9, characterized in that the divider consists of a dichroic filter (F1) that reflects B and R and transmits G or vice versa.

11. Display device according to one of the preceding claims, characterized in that the two optical channels (Cg, Crb) are placed at 90° as are the two matrices (Mg, Mrb) assigned to each of these channels, the merging of the two channels being achieved by means of a semi-transparent mirror (14) or a dichroic recombining mirror inclined at 45°.

12. Display device according to one of the preceding claims, characterized in that in the case of the green channel (Cg), two neighbouring pixels (8a, 8b) are illuminated by two beams of green light G, whereas in the case of the red-blue channel (Crb), two neighbouring pixels (8a, 8b) are assigned to the red R and to the blue B, respectively.

13. Display device according to one of the preceding claims, characterized in that a Fresnel lens (L) is placed between the optical divider (F1) and the liquid-crystal matrices 14.

14. Display device according to claim 13, characterized in that a simple mirror (7) is placed between the Fresnel lens (L) and the liquid-crystal matrices (Mg, Mrb) in order to fold the beam, preferably at 90°.

15. Display device according to one of the preceding claims, characterized in that the light source (1) is equipped with an ellipsoidal reflector (2).
